(19) United States
(12) Patent Application Publication
(10) Pub. No.: US 2026/0039462 A1
(43) Pub. Date: Feb. 5, 2026

(54) CONTROL CHIP, SENSING CHIP AND SENSING SYSTEM CONTROL METHOD WITH INFORMATION SECURITY MECHANISM

(71) Applicant: PixArt Imaging Inc., Hsin-Chu City (TW)

(72) Inventor: Jr-Kai Liang, Hsin-Chu City (TW)

(73) Assignee: PixArt Imaging Inc., Hsin-Chu City (TW)

(21) Appl. No.: 18/795,172

(22) Filed: Aug. 5, 2024

(51) Int. Cl. H04L 9/08

(52) U.S. Cl. CPC H04L 9/088

(57) ABSTRACT

A control chip, comprising: a control circuit, configured to encrypt output information by a key to generate encrypted information, and configured to output the encrypted information to a sensor via a transmission path, wherein the transmission path and the sensor are outside the control chip. A sensing chip is also disclosed, comprising: a sensor, configured to encrypt output information by a key to generate encrypted information, and outputs the encrypted information to a control circuit via a transmission path, wherein the control circuit and the transmission path are outside the sensing chip. A corresponding sensing system control method is also disclosed. Thereby a proper information security mechanism can be provided, to enhance the information security of information transmitted between different chips inside an electronic device.

### BACKGROUND OF THE INVENTION

### 1. Field of the Invention

The present invention relates to a control chip, a sensing chip and a sensing system control method, and particularly relates to a control chip, a sensing chip and a sensing system control method which have an information security mechanism.

### 2. Description of the Prior Art

An electronic device may comprise a plurality of chips provided therein. A conventional information security mechanism may only provide protection for the information transmitted between different electronic devices, but does not provide any information protection for the information transmitted between different chips in a single electronic device. Accordingly, the information transmitted between chips may easily be stolen.

Therefore, a proper information security mechanism is needed.

### SUMMARY OF THE INVENTION

One objective of the present invention is to provide a control chip with a proper information security mechanism.

Another objective of the present invention is to provide a sensing chip with a proper information security mechanism.

Still another objective of the present invention is to provide a sensing chip with a proper information security mechanism.

One embodiment of the present invention discloses a control chip, comprising: a control circuit, configured to encrypt output information by a key to generate encrypted information, and configured to output the encrypted information to a sensor via a transmission path, wherein the transmission path and the sensor are outside the control chip.

Another embodiment of the present invention discloses a sensing chip, comprising: a sensor, configured to encrypt output information by a key to generate encrypted information, and outputs the encrypted information to a control circuit via a transmission path, wherein the control circuit and the transmission path are outside the sensing chip.

Still another embodiment of the present invention discloses a sensing system control method, applied to a sensing system comprising a sensor in a sensing chip, a transmission path and a control circuit in a control chip, comprising: encrypting first output information using a first key by the control circuit to generate first encrypted information; outputting the first encrypted information to the transmission path by the control circuit; and receiving the first encrypted information by the sensor via the transmission path; wherein the sensing chip and the control chip are independent from each other, and the transmission path is outside the sensing chip and the control chip.

In view of above-mentioned embodiments, a proper information security mechanism can be provided, to enhance the information security of information transmitted between different chips inside an electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a control chip with an information security mechanism, according to one embodiment of the present invention.

FIG. 2 is a block diagram illustrating a sensing chip with an information security mechanism, according to one embodiment of the present invention.

FIG. 3 is a block diagram illustrating a sensing system with an information security mechanism, according to one embodiment of the present invention.

FIG. 4 is a flow chart illustrating a sensing system control method, according to one embodiment of the present invention.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

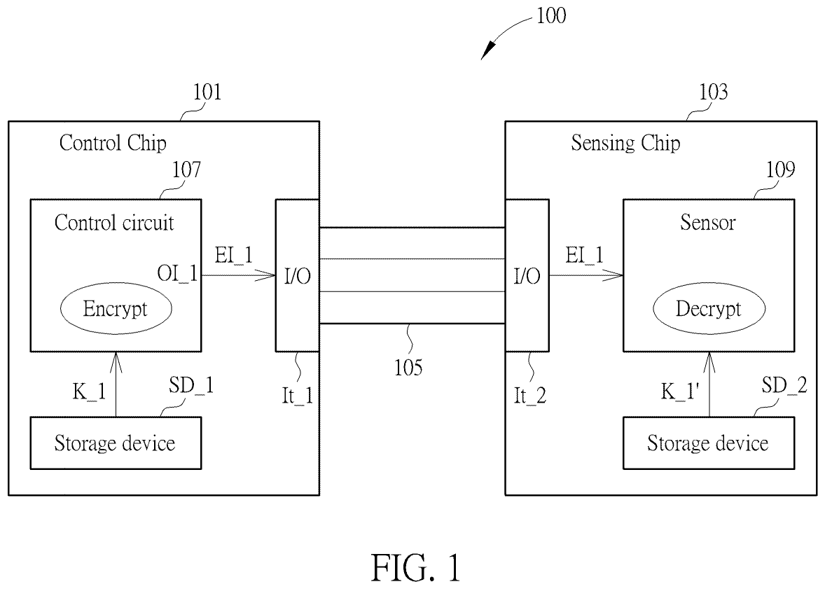

FIG. 1 is a block diagram illustrating a control chip with an information security mechanism, according to one embodiment of the present invention. As shown in FIG. 1, the sensing system 100 comprises a control chip 101, a sensing chip 103 and a transmission path 105. The control chip 101 and the sensing chip 103 are different chips. In other words, the control chip 101 and the sensing chip 103 are independent from each other. Also, the transmission path 105 is outside the control chip 101 and the control chip 103 and coupled between the control chip 101 and the control chip 103.

The control chip 101 may comprise a control circuit 107, the I/O interface It_1 and a storage device SD_1. The control circuit 107 is a circuit with a computing function, such as a MCU (Microcontroller Unit), or a CPU (Central Processing Unit). The I/O interface It_1 is an interface which may follow various communication protocols. For example, the I/O interface It_1 may follow the communication protocol, SPI, UART, I2C, or I3C, but not limited. Also, the transmission path 105 is a path with transmission functions, such as transmission lines or a bus.

The sensing chip 103 comprises a sensor 109, the I/O interface It_2 and a storage device SD_2. The I/O interface It_2 is an interface which may follow various communication protocols. For example, the I/O interface It_2 may follow the communication protocol, SPI, UART, I2C, or I3C, but not limited. In following embodiments, the transmission path 105 is coupled between the I/O interface It_1 and the I/O interface It_2. However, the transmission path 105 may be coupled to the control chip 101 and the sensor chip 103 by other ways. In one embodiment, the control chip 101 is configured to control an optical navigation system such as an optical mouse, and the sensor 109 is an optical sensor. Please note the scope of the present application is not limited to such example. In one embodiment, the sensor 109 is a touch sensor.

In the embodiment of FIG. 1, the control circuit 107 encrypts output information OI_1 (first output information) by a key K_1 (a first key) to generate encrypted information EI_1 (first encrypted information), and outputs the encrypted information EI_1 to the sensor 109 via the transmission path 105. The output information OI_1 may be information generated by the control circuit 107 or information received by the control circuit 107. In one embodiment, the output information OI_1 is information for setting operation parameters of the sensor 109. For example, the output information OI_1 comprises address or parameters for setting the exposure time, the gains or the operation clock signals of the sensor 109. In another embodiment, the control chip 101 or the sensing chip 103 may comprise addresses, buffers or registers, and the output information OI_1 comprises addresses of the sensing chip 103, or accessing addresses of the buffers or registers (i.e., values of registers). Such operation parameters or accessing parameters are also encrypted by the key K_1.

In one embodiment, the key K_1 is recorded in the storage device SD_1 inside the control chip 101. The control chip 101 does not output the key K_1 and does not receive the key K_1 from outwards, after the key K_1 has been recorded in the storage device SD_1. In one embodiment, the key K_1 is recorded in the storage device SD_1 while manufacturing the control chip 101. After the manufacturing of the control chip 101 is completed and starts to work, the control chip 101 does not output the key K_1 to any other device and does not receive the key K_1 again. However, in one embodiment, the key stored in the control chip 101 may be updated to another key. In one embodiment, the updating function of the key K_1 can be activated or non-activated. For example, the updating function of the key K_1 can be activated or non-activated by e-fuses provided in the control chip 101 or other setting methods which the control circuit 107 can execute.

In one embodiment, the updating is performed by a circuit inside the control chip 101 (e.g., the control circuit 107) based on a rule recorded in the control chip 101. For example, the recorded rule contains 10 keys, and the updating may mean change the current key to another key among the 10 keys. Such operation may be controlled by another component in the same electronic device. For example, the control circuit 107 may be controlled by the sensor 109 to perform the updating. In one embodiment, the updating cannot be controlled by signals from outer of the control chip 101, thereby the information security mechanism may be further enhanced.

After receiving the encrypted information EI_1, the sensor 109 may use a key K_1′ to decrypt the encrypted information EI_1. The key K_1′ may be a key which corresponds to the key K_1 and is used for decrypting encrypted information which is encrypted by the key K_1. In one embodiment, the key K_1 and the key K_1′ may have the same contents. However, in another embodiment, the key K_1 and the key K_1′ may have different contents. In one embodiment, the key K_1′ is recorded in the storage device SD_2 while manufacturing the sensing chip 103.

The encryption and decryption algorithm used in the embodiment of FIG. 1 may be selected corresponding to different requirements. For example, if simplified encryption and decryption are needed, the encryption and decryption algorithm nay be bit swap, bit reversed or XOR. If a higher security is needed, the encryption and decryption algorithm may be AES (Advanced Encryption Standard). However, the scope of the present invention is not limited to these algorithms.

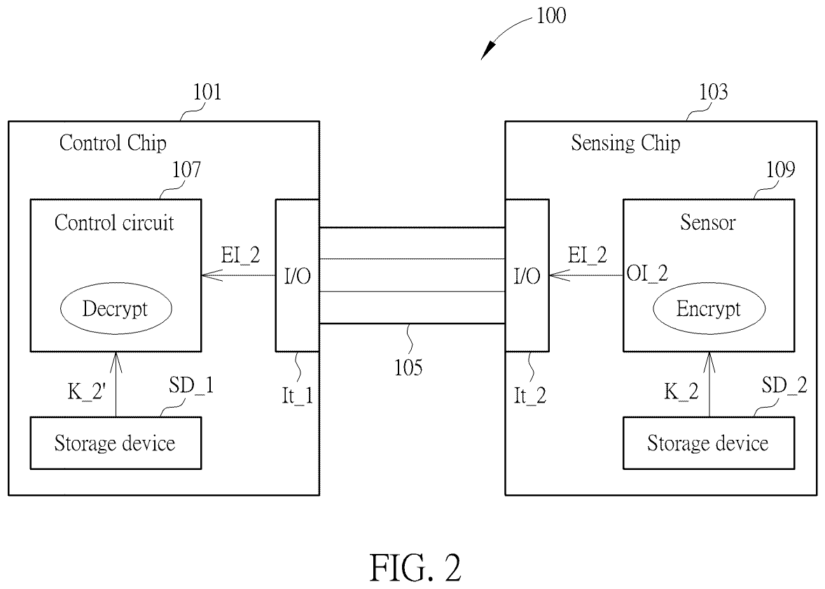

FIG. 2 is a block diagram illustrating a sensing chip with an information security mechanism, according to one embodiment of the present invention. In FIG. 2, the sensing system 100 also comprises the control chip 101, the sensing chip 103 and the transmission path 105. The control chip 101 and the sensing chip 103 are different chips. In other words, the control chip 101 and the sensing chip 103 are independent from each other. Also, the transmission path 105 is outside the control chip 101 and the control chip 103 and coupled between the control chip 101 and the control chip 103. The components comprised in the control chip 101 and the sensing chip 103 are the same as which shown in FIG. 1, thus are omitted for brevity here.

In the embodiment of FIG. 2, the sensor 109 encrypts output information OI_2 (second output information) by a key K_2 (a second key) to generate encrypted information EI_2 (second encrypted information), and outputs the encrypted information EI_2 to the control circuit 107 via the transmission path 105. In one embodiment, the output information OI_2 comprises sensing data generated by the sensor 103. For example, as above-mentioned, the sensing chip 103 may be used for an optical navigation system and the sensor 109 is an optical sensor. In such case, the output information OI_2 comprises motion data generated by the optical sensor. Such sensing data is also encrypted to generate the encrypted data EI_2.

In one embodiment, the key K_2 is recorded in the storage device SD_2 inside the sensing chip 103. The sensing chip 103 does not output the key K_2 and does not receive the key K_2 from outwards, after the key K_2 has been recorded in the storage device SD_2. In one embodiment, the key K_2 is recorded in the storage device SD_2 while manufacturing the sensing chip 103. After the manufacturing of the sensing chip 103 is completed and starts to work, the sensing chip 103 does not output the key K_2 to any other device and does not receive the key K_2 again. However, in one embodiment, the key stored in the sensing chip 103 may be updated to another key. In one embodiment, the updating function of the key K_2 can be activated or non-activated. For example, the updating function of the key K_2 can be activated or non-activated by e-fuses provided in the sensing chip 103 or other setting methods which the sensor 109 can execute.

In one embodiment, the updating is performed by a circuit inside the sensing chip 103 (e.g., the sensor 109) based on a rule recorded in the sensing chip 103. For example, the recorded rule contains 10 keys, and the updating may mean change the current key to another key among the 10 keys. Such operation may be controlled by another component in the same electronic device. For example, the sensor 109 may be controlled by the control circuit 107 to perform the updating. In one embodiment, the updating cannot be controlled by signals from outer of the sensing chip 103, thereby the information security mechanism may be further enhanced.

After receiving the encrypted information EI_2, the control circuit 107 may use a key K_2′ to decrypt the encrypted information EI_2. The key K_2′ may be a key which corresponds to the key K_2 and is used for decrypting encrypted information which is encrypted by the key K_2. In one embodiment, the key K_2 and the key K_2′ may have the same contents. However, in another embodiment, the key K_2 and the key K_2′ may have different contents. In one embodiment, the key K_2′ is recorded in the storage device SD_1 while manufacturing the control chip 101.

The encryption and decryption algorithm used in the embodiment of FIG. 2 may be selected corresponding to different requirements. For example, if simplified encryption and decryption are needed, the encryption and decryption algorithm can be bit swap, bit reversed, XOR or other simple methods. If a higher security is needed, the encryption and decryption algorithm can be AES or other more complicated methods.

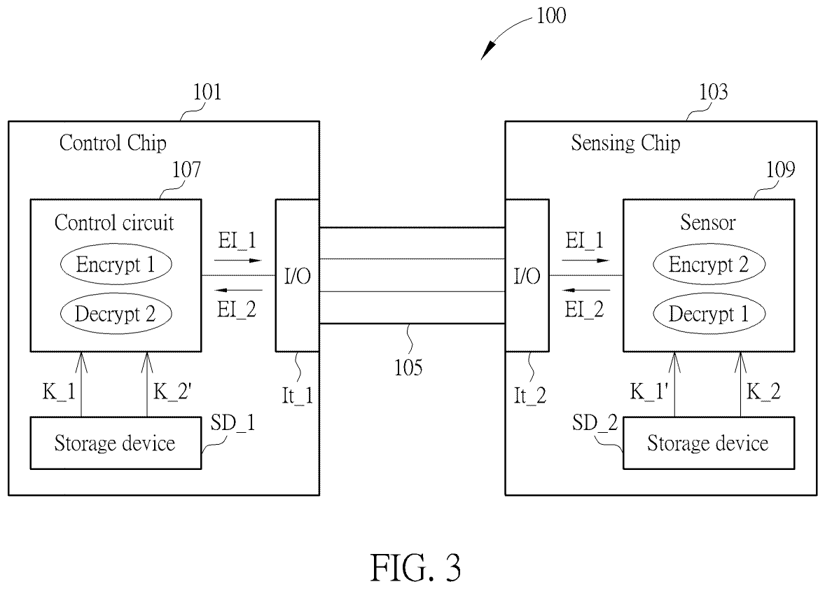

In the embodiments of FIG. 1 and FIG. 2, only one of the control chip 101 and the sensing chip 103 has the function of encryption and the other one of the control chip 101 and the sensing chip 103 has the function of decryption. However, either the control chip 101 or the sensing chip 103 may have the function of encryption and decryption. FIG. 3 is a block diagram illustrating a sensing system with an information security mechanism, according to one embodiment of the present invention. The embodiment illustrated in FIG. 3 may be regarded as a combined embodiment of the embodiments shown in FIG. 1 and FIG. 2.

In FIG. 3, the sensing system 100 also comprises the control chip 101, the sensing chip 103 and the transmission path 105. The control chip 101 and the sensing chip 103 are different chips. In other words, the control chip 101 and the sensing chip 103 are independent from each other. Also, the transmission path 105 is outside the control chip 101 and the control chip 103 and coupled between the control chip 101 and the control chip 103. The components comprised in the control chip 101 and the sensing chip 103 are the same as which shown in FIG. 1, thus are omitted for brevity here.

In the embodiment of FIG. 3, the control circuit 107 encrypts the output information OI_1 to generate the encrypted information EI_1 by the key K_1, and outputs the output information OI_1 to the sensor 109 via the transmission path 105. The sensor 109 can decrypt the encrypted information EI_1 by the key K_1′. Similarly, the sensor 109 encrypts the output information OI_2 to generate the encrypted information EI_2 by the key K_2, and outputs the output information OI_2 to the control circuit 107 via the transmission path 105. The control circuit 107 can decrypt the encrypted information EI_2 by the key K_2′.

As above-mentioned, in one embodiment, the output information OI_1 is information for setting operation parameters of the sensor 109. For example, the output information OI_1 comprises parameters for setting the exposure time, the gains or the operation clock signals of the sensor 109. In another embodiment, the control chip 101 or the sensing chip 103 may comprise buffers or registers, and the output information OI_1 comprises accessing addresses of the buffers or registers. Such operation parameters or accessing parameters are also encrypted by the key K_1. Also, in one embodiment, the output information OI_2 comprises sensing data generated by the sensor 103. For example, as above-mentioned, the sensing chip 103 may be used for an optical navigation system and the sensor 109 is an optical sensor. In such case, the output information OI_2 comprises motion data generated by the optical sensor. Such sensing data is also encrypted to generate the encrypted data EI_2.

In the embodiment of FIG. 3, the key K_1 and K_2′ may be stored in a storage device SD_1 provided inside the control chip 101. Further, the key K_1′ and K_2 may be stored in a storage device SD_2 provided inside the sensor chip 103. In such embodiment, the key K_1 and K_2 may be identical, but may be different as well. Other details of the keys K_1, K_2, K_1′ K_2′, the encryption algorithm and the decryption algorithm are described in the embodiments of FIG. 1 and FIG. 2, thus descriptions thereof are omitted for brevity here.

In the figures above-mentioned embodiments, the sensor 109 directly receives the output information EI_1 and decrypts the output information EI_1. However, the output information EI_1 may be stored to a register or a buffer inside the sensing chip 103, and then the sensor 109 decrypts the output information EI_1 stored in the register or the buffer. Similarly, the output information EI_2 may be stored to a register or a buffer inside the control chip 101, and then the control circuit 107 decrypts the output information EI_2 stored in the register or the buffer.

As above-mentioned, the key K_1 may be recorded in the storage device SD_1 of the control chip 101 while manufacturing the control chip 101, and the key K_2 maybe recorded in the storage device SD_2 of the sensing chip 103 while manufacturing the sensing chip 103. However, the keys K_1, K_2 may be respectively recorded to the control chip 101 and the sensing chip 103 by other methods.

For example, the control chip 101 and the sensing chip 103 may be send to downstream manufacturers for further processing, after manufactured by the factory and before selling to end consumers. The downstream manufacturers may record the keys K_1, K_2 to the control chip 101 or the sensing chip 103 using following examples:

### Example 1

Write Initial encryption keys individually before the control chip 101 and the sensing chip 103 installed on a PCB (printed circuit board).
a. control chip 101: Write the key by the control circuit 107 which downloads a FW (firmware) path over a debug port thereof or over a dedicated download FW path
b. sensing chip 103: Write the key by sensor communicated interface, e.g., I2C/I3C/SPI/UART. The initial key is one-time programmed and non-readable to prevent hack after key written.

In one example, the initial key is needed to be handled carefully during manufacturing of the control chip 101 and the sensing chip 103 to prevent key leakage.

### Example 2

The initial key is embedded in FW of the control circuit 107. The initial key will be written to the sensor chip 103 when the pcb is 1st power-on inside the factory of the downstream manufacturer.
a. control chip 101: The initial key is embedded in the fw of the control circuit 107, so the initial key can be acquired by downloading fw to the control circuit 107 without an additional process to write keys.
b. sensing chip103: Write the key by sensor communicated interface, e.g., I2C/I3C/SPI/UART. The initial key is one-time programmed and non-readable to prevent hack after key written.

In such case, the keys may be controlled by control circuit FW developer, and would not need to provide keys to others for downloading FW or keys.

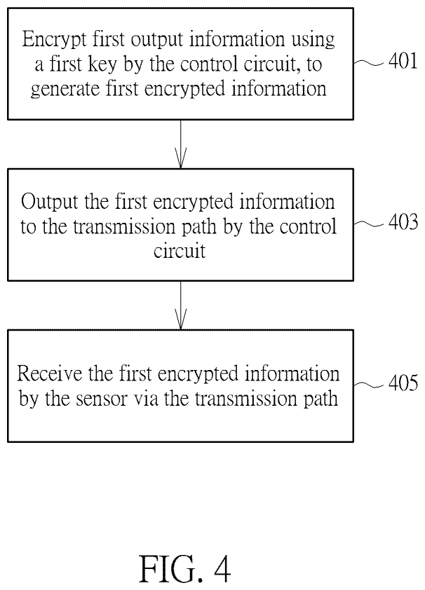

In view of above-mentioned embodiments, a sensing system control method may be acquired. FIG. 4 is a flow chart illustrating a sensing system control method according to one embodiment of the present invention. The sensing system control method is applied to a sensing system comprising a sensor in a sensing chip, a transmission path and a control circuit in a control chip, such as the control chip 101, the sensing chip 103 and the transmission path 105 in FIG. 1, FIG. 2 and FIG. 3. The control chip and the sensing chip are independent from each other, and the transmission path is outside the sensing chip and the control chip. The sensing system control method comprises:

### Step 401

Encrypt first output information using a first key by the control circuit (e.g., using the key K_1 by the control circuit 107 in FIG. 1), to generate first encrypted information (e.g., encrypted information EI_1 in FIG. 1).

### Step 403

Output the first encrypted information to the transmission path by the control circuit.

### Step 405

Receive the first encrypted information by the sensor via the transmission path.

The steps 401, 403 and 405 correspond to the embodiment of FIG. 1. If the sensing system control method corresponds to the embodiment of FIG. 2, it may comprise following steps: encrypting second output information using a second key by the sensor (e.g., using the key K_2 by the sensor 109 in FIG. 2) to generate second encrypted information (e.g., encrypted information EI_2 in FIG. 2); and outputting the second encrypted information to the control circuit via the transmission path.

In view of above-mentioned embodiments, a proper information security mechanism can be provided, to enhance the information security of information transmitted between different chips inside an electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control chip, comprising:
a control circuit, configured to encrypt output information by a key to generate encrypted information, and configured to output the encrypted information to a sensor via a transmission path, wherein the transmission path and the sensor are outside the control chip.

2. The control chip of claim 1, wherein the control chip is configured to control an optical navigation system and the sensor is an optical sensor.

3. The control chip of claim 1, wherein the output information is information for setting operation parameters of the sensor, wherein the operation parameters include addresses or values of registers.

4. The control chip of claim 1, wherein the output information comprises accessing addresses.

5. The control chip of claim 1, wherein the key is recorded in a storage device inside the control chip, wherein the control chip does not output the key and does not receive the key from outwards, after the key has been recorded in the storage device.

6. A sensing chip, comprising:
a sensor, configured to encrypt output information by a key to generate encrypted information, and outputs the encrypted information to a control circuit via a transmission path, wherein the control circuit and the transmission path are outside the sensing chip.

7. The sensing chip of claim 6, wherein the output information comprises sensing data generated by the sensor.

8. The sensing chip of claim 6, wherein the sensing chip is for an optical navigation system and the sensor is an optical sensor.

9. The sensing chip of claim 8, wherein the output information comprises motion data generated by the optical sensor.

10. The sensing chip of claim 6, wherein the key is recorded in a storage device inside the sensing chip, wherein the sensing chip does not output the key and does not receive the key from outwards, after the key has been recorded in the storage device.

11. A sensing system control method, applied to a sensing system comprising a sensor in a sensing chip, a transmission path and a control circuit in a control chip, comprising:
encrypting first output information using a first key by the control circuit to generate first encrypted information;
outputting the first encrypted information to the transmission path by the control circuit; and
receiving the first encrypted information by the sensor via the transmission path;
wherein the sensing chip and the control chip are independent from each other, and the transmission path is outside the sensing chip and the control chip.

12. The sensing system control method of claim 11, wherein the sensing system is an optical navigation system and the sensor is an optical sensor.

13. The sensing system control method of claim 11, wherein the first output information is information for setting operation parameters of the sensor, wherein the operation parameters include addresses or values of registers.

14. The sensing system control method of claim 11, wherein the first output information comprises accessing addresses.

15. The sensing system control method of claim 11, wherein the first key is recorded in a storage device inside the control chip, wherein the control chip does not output the first key and does not receive the first key from outwards, after the first key has been recorded in the storage device.

16. The sensing system control method of claim 11, further comprising:
encrypting second output information using a second key by the sensor to generate second encrypted information; and
outputting the second encrypted information to the control circuit via the transmission path.

17. The sensing system control method of claim 16, wherein the second output information comprises sensing data generated by the sensor.

18. The sensing system control method of claim 16, wherein the sensing system is an optical navigation system and the sensor is an optical sensor, wherein the second output information comprises motion data generated by the optical sensor.

19. The sensing system control method of claim 16, further comprising:
storing the second key to the sensor while manufacturing the sensing chip.

20. The sensing system control method of claim 16, wherein the second key is recorded in a storage device inside the sensing chip, wherein the sensing chip does not output the second key and does not receive the second key from outwards, after the second key has been recorded in the storage device.
